(19) United States
(12) Patent Application Publication
(10) Pub. No.: US 2025/0278732 A1
(43) Pub. Date: Sep. 4, 2025

(54) GLOBAL RELYING PARTY SYSTEM FOR VALIDATING DIGITAL IDENTITY CREDENTIALS

(71) Applicant: Visa International Service Association, San Francisco, CA (US)

(72) Inventors: Simon Hurry, Foster City, CA (US); Christopher M. McMillan, Castle Rock, CO (US); Kiushan Pirzadeh, Foster City, CA (US); Andreas Zingler Aabye, Redwood City, CA (US); Nikhil Kumar Jha, San Ramon, CA (US)

(73) Assignee: Visa International Service Association, San Francisco, CA (US)

(21) Appl. No.: 19/065,787

(22) Filed: Feb. 27, 2025

Related U.S. Application Data
(60) Provisional application No. 63/559,718, filed on Feb. 29, 2024.

(51) Int. Cl. G06Q 20/40; G06Q 20/38; H04L 9/08; H04L 9/32

(52) U.S. Cl. CPC G06Q 20/4014; G06Q 20/38215; G06Q 20/3825; G06Q 20/3829; H04L 9/0825; H04L 9/3213; H04L 9/3247; H04L 9/3263

(57) ABSTRACT

Techniques described herein enable a digital certificate (e.g., a mobile Driver's License (mDL)) to be used as a proxy for a credential. Using the digital certificate as a proxy for the credential can improve transaction security and benefit from trust established by processes implemented by a certification authority. The techniques can add functionality to a digital certificate since the digital certificate can be used as an account credential in addition to its previous function.

### CROSS-REFERENCES TO RELATED APPLICATIONS

This application claims priority to U.S. Provisional Application No. 63/559,718, filed on Feb. 29, 2024, which is herein incorporated by reference in its entirety.

### BACKGROUND

Mobile Driver's Licenses (mDLs) are becoming a focus for identity service providers. mDLs offer a number of benefits over traditional plastic IDs: they are harder to counterfeit, quicker to update, can be used online, and offer a wider range of functionality to the ecosystem. Relying parties (parties that use the information retrieved from the mDL) may require validation of the mDL by a trusted party. While an issuing entity that issued the mDL may be available to validate the mDL, the relying party may not be familiar with the issuing entity and therefore may not trust a validation by the issuing entity. In some embodiments, the issuing entity may not be available to the relying party (e.g., an organization in a foreign jurisdiction that may not be set up for communication with organizations in other jurisdictions).

Embodiments of the disclosure address these problems and other problems individually and collectively.

### BRIEF SUMMARY

One embodiment of the invention includes a method comprising: receiving, by a processing network computer from a user device, account identifying information associated with a user account and a digital identity certificate including identity information; associating, by the processing network computer, a token representing the account identifying information with the digital identity certificate; and transmitting, by the processing network computer, a message to the user device indicating that the digital identity certificate provisioning is complete with respect to the user account.

One embodiment of the invention includes a system comprising: one or more storage media storing first instructions; and one or more processors configured to execute the instructions to cause the system to perform operations comprising: receiving, by a processing network computer from a user device, account identifying information associated with a user account and a digital identity certificate including identity information; associating, by the processing network computer, a token representing the account identifying information with the digital identity certificate; and transmitting, by the processing network computer, a message to the user device indicating that the digital identity certificate provisioning is complete with respect to the user account.

One embodiment of the invention includes one or more non-transitory computer-readable storage media storing instructions that, upon execution by one or more processors of a system (e.g., a processing network computer), cause the system to perform operations comprising: receiving, by a processing network computer from a user device, account identifying information associated with a user account and a digital identity certificate including identity information; associating, by the processing network computer, a token representing the account identifying information with the digital identity certificate; and transmitting, by the processing network computer, a message to the user device indicating that the digital identity certificate provisioning is complete with respect to the user account.

One embodiment of the invention includes a method comprising: receiving, by a processing network computer from a resource provider computer for a transaction, a first transaction authorization request message that includes a digital identity certificate including identity information and transaction information associated with the transaction; determining, by the processing network computer, a token associated with the identity information from a plurality of tokens associated with the identity information based at least in part on the transaction information and the digital identity certificate; retrieving, by the processing network computer, the token; generating, by the processing network computer, a second transaction authorization request that includes the token; transmitting, by the processing network computer and to an authorizing entity computer, the second transaction authorization request; receiving, by the processing network computer and from the authorizing entity computer, a first transaction authorization response message generated based at least in part on the token; and transmitting, by the processing network computer and to the resource provider computer, a second transaction authorization response message indicating whether the transaction was authorized.

One embodiment of the invention includes a system comprising: one or more storage media storing first instructions; and one or more processors configured to execute the instructions to cause the system to perform operations comprising: receiving, by a processing network computer from a resource provider computer for a transaction, a first transaction authorization request message that includes a digital identity certificate including identity information and transaction information associated with the transaction; determining, by the processing network computer, a token associated with the identity information from a plurality of tokens associated with the identity information based at least in part on the transaction information and the digital identity certificate; retrieving, by the processing network computer, the token; generating, by the processing network computer, a second transaction authorization request that includes the token; transmitting, by the processing network computer and to an authorizing entity computer, the second transaction authorization request; receiving, by the processing network computer and from the authorizing entity computer, a first transaction authorization response message generated based at least in part on the token; and transmitting, by the processing network computer and to the resource provider computer, a second transaction authorization response message indicating whether the transaction was authorized.

One embodiment of the invention includes one or more non-transitory computer-readable storage media storing instructions that, upon execution by one or more processors of a system, cause the system to perform operations comprising: receiving, by a processing network computer from a resource provider computer for a transaction, a first transaction authorization request message that includes a digital identity certificate including identity information and transaction information associated with the transaction; determining, by the processing network computer, a token associated with the identity information from a plurality of tokens associated with the identity information based at least in part on the transaction information and the digital identity certificate; retrieving, by the processing network computer, the token; generating, by the processing network computer, a second transaction authorization request that includes the token; transmitting, by the processing network computer and to an authorizing entity computer, the second transaction authorization request; receiving, by the processing network computer and from the authorizing entity computer, a first transaction authorization response message generated based at least in part on the token; and transmitting, by the processing network computer and to the resource provider computer, a second transaction authorization response message indicating whether the transaction was authorized.

### BRIEF DESCRIPTION OF THE DRAWINGS

FIG. 1 shows a block diagram of a system, according to an embodiment.

FIG. 2 illustrates a flowchart for provisioning a token to a digital wallet using a digital identity certificate (e.g., a mobile driver's license), according to an embodiment.

FIGS. 3-4 illustrate a flowchart for processing a payment transaction using a digital identity certificate (e.g., a mobile driver's license), according to an embodiment.

FIG. 5 illustrates a flowchart for mitigating unauthorized card use using a digital identity certificate, according to an embodiment.

FIG. 6 shows a block diagram of a user device, according to an embodiment.

FIG. 7 shows a block diagram of a processing network computer, according to an embodiment.

### TERMS

Before discussing embodiments of the invention, some description of some terms may be helpful.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include a cryptographic key that may be shared openly and publicly. The public key may be designed to be shared and may be configured such that any information encrypted with the public key may only be decrypted using a private key associated with the public key (i.e., a public/private key pair).

A “private key” may include any cryptographic key that may be protected and secure. A private key may be securely stored at an entity and may be used to decrypt any information that has been encrypted with an associated public key of a public/private key pair associated with the private key.

A “public/private key pair” may refer to a pair of linked cryptographic keys generated by an entity. The public key may be used for public functions such as encrypting a message to send to the entity or for verifying a digital signature which was supposedly made by the entity. The private key, on the other hand may be used for private functions such as decrypting a received message or applying a digital signature. In some embodiments, the public key may be authorized by a body known as a certification authority (CA) which stores the public key in a database and distributes it to any other entity which requests it. The private key can typically be kept in a secure storage medium and will usually only be known to the entity. Public and private keys may be in any suitable format, including those based on Rivest-Shamir-Adleman (RSA) or elliptic curve cryptography (ECC).

A “digital signature” may include any electronic signature for a digital document or a message. A digital signature may be a numeric data value, an alphanumeric data value, or any other type of data. In some embodiments, a digital signature may be a unique data value generated from a digital content (or data packet) and a private key using a cryptographic algorithm. In some embodiments, a validation algorithm using a public key may be used to verify the signature. A digital signature may be used to demonstrate the veracity of the authority that issued credentials (e.g., a digital license) associated with the digital signature.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

A “certificate” or “digital certificate” may include an electronic document and/or data file. In some cases, the certificate or the digital certificate may be a device certificate. In some embodiments, a digital certificate may use a digital signature to bind a public key with data associated with an identity. A digital certificate may be used to prove the ownership of a public key. The certificate may include one or more data fields, such as the legal name of the identity, a serial number of the certificate, a valid-from and valid-to date for the certificate, certificate related permissions, etc. A certificate may contain a “valid-from” date indicating the first date the certificate is valid, and a “valid-to” date indicating the last date the certificate is valid. A certificate may also contain a hash of the data in the certificate including the data fields. A certificate can be signed by a certification authority. For example, a digital certificate may be provided by a certification authority in connection with a digital license provided by an Issuing Authority. The digital certificate may help to authenticate the Issuing Authority. An example of a digital certificate is a digital identity certificate. The digital identity certificate may be a mobile driver's license (mDL).

A “certification authority” (e.g., an identity agency) may include an entity that issues digital certificates. A certification authority may prove its identity using a certification authority certificate, which includes the certification authority's public key. A certification authority certificate may be signed by another certification authority's private key or may be signed by the same certification authority's private key. The latter is known as a self-signed certificate. The certification authority may maintain a database of all certificates issued by the certification authority. The certification authority may maintain a list of revoked certificates. The certification authority may be operated by an entity, for example, a department of government (e.g., department of motor vehicles), a processing network entity that operates a processing network computer, an issuer, an acquirer, and/or a central bank, etc.

An “Issuing Authority” may include an entity that issues credentials to a user, typically using an issuing entity computer to do so. An issuing entity may be a governmental agency, a medical service provider, a document repository, an access administrator, etc. An issuing entity may also issue credentials in form of a digital license stored on a user device, such as a cellular telephone, smart card, tablet, or laptop to the user.

A “user” may include an individual or a computational device. In some embodiments, a user may be associated with one or more personal accounts and/or user devices (e.g., mobile devices). The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A user device may include a contactless device (e.g., a device that can communicate over a near field communication (NFC) antenna). A contactless device may include any smart device or form factor containing an NFC antenna that can transmit information to another smart device through the NFC antenna. Examples of contactless devices may include, but is not limited to, mobile phones, smart watches, smart wearables, TVs, laptops, payment cards (debit, credit, prepaid others), badges, tags, key fobs, home assistant devices, soundbars, refrigerators, cars, IOT devices etc.

A “server computer” is typically a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “communication channel” can include a medium through which message(s) can be provided. A communication channel can include a physical transmission medium (e.g., a wire, a contact interface, etc.), an over-the-air communication medium (e.g., using electromagnetic signals, etc.), a logical medium (e.g., application programming interfaces (APIs), etc.), and/or a combination thereof.

A “transaction” may be any interaction or exchange between two or more parties. For example, a transaction may include a first entity requesting resources from a second entity. In this example, the transaction is completed when the resources are either provided to the first entity or the transaction is declined.

An “interaction” may include a reciprocal action or influence that involves more than one actor. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like.

An “access device” may be any suitable device that provides access to a remote system. An access device may also be used for communicating with a coordination computer, a communication network, or any other suitable system. An access device may generally be located in any suitable location, such as at the location of a relying party (e.g., a user of a mobile device, a resource provider). An access device may be in any suitable form. Some examples of access devices include POS or point of sale devices (e.g., POS terminals), cellular phones, personal digital assistants (PDAs), personal computers (PCs), tablet PCs, hand-held specialized readers, set-top boxes, electronic cash registers (ECRs), automated teller machines (ATMs), virtual cash registers (VCRs), kiosks, security systems, access systems, barcode readers, QR code readers, and the like. In some embodiments, the access device may comprise a reader, a processor, and a computer-readable medium. An access device may use any suitable contact or contactless mode of operation to send or receive data from, or associated with, a user device. For example, access devices can have card readers that can include electrical contacts, radio frequency (RF) antennas, optical scanners, bar code readers, or magnetic stripe readers to interact with user devices.

An “access request” may include a request for access to a resource. The resource may be a physical location (e.g., concert venue, apartment building, office space), a physical resource (e.g., good), a digital resource (e.g., electronic document, electronic data, etc.), or a service. In some cases, an access request may be submitted by transmission of an access request message that includes access request data. Typically, a device associated with a requestor may transmit the access request message to a device associated with a relying part in charge of granting the requested access.

An “access credential” may include any suitable data that can be used to access a resource or create data that can access a resource. A credential may be a string of numbers, letters, or any other suitable characters, as well as any object or document that can serve as confirmation. In some embodiments, the access credential could include data that can be used to access a location or to access secure data. Such information may be a driver's license, a vaccination record, a national passport, a medical prescription, a recreational license, a recreational permit, a voter registration confirmation, an identification document to access a building, ticket information for an event, data to access a building, transit ticket information, passwords, biometrics or other credentials to access secure data, etc. According to various embodiments, the access credential(s) may be provided in form of a digital license provisioned on a user device. For example, the digital license may be provisioned on the user device by an issuing authority that issued the digital license. In some embodiments, the digital license may be provisioned on the user device by an authenticating authority that authenticates the issuing authority and/or the digital license.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

“Payment credentials” may include any suitable information associated with an account (e.g., a payment account and/or payment device associated with the account). Such information may be directly related to the account or may be derived from information related to the account. Payment credentials may be any information that identifies or is associated with a payment account. Payment credentials may be provided to make a payment from a payment account. Payment credentials can also include a username, an expiration date, a gift card number or code, and any other suitable information. Examples of account information may include a PAN (primary account number or “account number”), username, expiration date, and verification values such as CVV, dCVV, CVV2, dCVV2, and CVC3 values.

A “digital wallet” can include an application executing on an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may be a transfer application.

An “application” may be computer code or other data stored on a computer readable medium (e.g., memory element or secure element) that may be executable by a processor to complete a task.

### DETAILED DESCRIPTION

As described above in the Summary, embodiments are directed to techniques that enable digital certificates to be used to improve security of transactions. Digital certificates may be issued by an issuing authority. For example, a digital certificate may include a mobile Driver's License (mDL) issued by a local Department of Motor Vehicles (DMV). The issuing authority may implement security measures to ensure that the digital certificate is issued to a user device based on confidence that the user device is associated with the same user that the digital certificate is associated with.

Building from the security measures implemented by the digital certificate issuing authority, a processing network computer can use information associated with (e.g., linked to, included in) the digital certificate to validate whether a transaction should be allowed to occur. Embodiments enable processing network computers to validate the authenticity of a digital certificate using a public key infrastructure. Embodiments also enable processing network computers to check whether a digital certificate corresponds to account identifying information. For example, if a fraudster uses their own user device to try to conduct a transaction using a fraud victim's account identifying information, the processing network computer can be configured to prevent the transaction from taking place because identity information included in the fraudsters mDL stored by the fraudster's user device may not correspond with the account owner's information associated with the account identifying information.

Details of some embodiments of the present disclosure will now be described in greater detail. For clarity, a certain number of components are shown in the subsequent figures. It is understood, however, that embodiments of the disclosure may include more than one of each component. In addition, the components in each figure may communicate via any suitable communication medium (including the internet, NFC, etc.), using any suitable communication protocol.

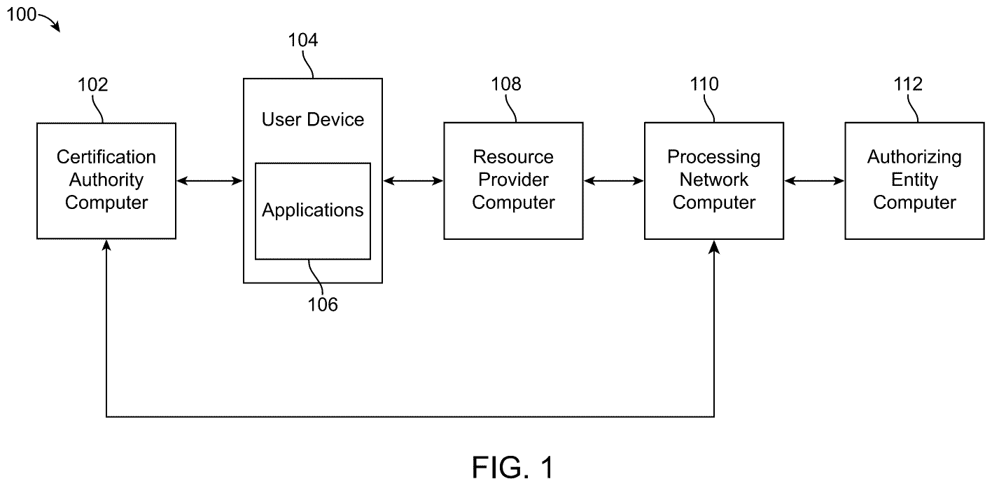

FIG. 1 shows a block diagram of a system 100, according to an embodiment. System 100 includes a certification authority computer 102, a user device 104, a resource provider computer 108, a processing network computer 110, and an authorizing entity computer 112.

The certification authority computer 102 may be owned and/or operated by a certification authority. Certification authorities are described above in detail. The certification authority computer 102 can generate and/or issue a digital certificate. The certification authority computer 102 may determine, generate, and/or receive identify information to be included in a digital certificate. The certification authority may use a private key to sign the digital certificate so that another computer can use a public key paired with the private key to determine if the digital certificate is authentic. That is, the digital certificate may include a digital signature that binds a public key (paired with the private key of the certification authority) with data associated with an identity.

The user device 104 may be a communication device (e.g., a mobile phone, a smart watch, a tablet) operated by a first user. The user device 104 can be used to conduct interactions (e.g., transactions) and access resources. User devices have been described above in further detail. In certain embodiments, the user device 104 may have any number of applications 106 installed thereon. The applications 106 may include a digital wallet application and/or a service provider application that can store digital identity certificates, among other things. A digital identity certificate is an example of a digital certificate, which are described above in further detail. The digital identity certificate may include identity information such as one or more of a name, an address, a date of birth, an eye color, a hair color, a height, a gender, a photograph, a signature, an ID number, an issuance date, an expiration date, a citizenship, a nationality, a resident state, an institution associated with the digital identity certificate, indications of restrictions (e.g., corrective lenses, learner's permit, etc.), an organ donor indication, and/or a marital status, etc. Examples of digital identity certificates include a digital/mobile driver's license, a digital state identification card, a digital passport, a military identification, a social security card, a green card, a student identification, a library identification, etc. The digital certificate can be cryptographically/digitally signed by a private key (e.g., by the certification authority computer 102). The private key digital signature, in combination with a public key that is part of a keypair with the private key can be used to verify the authenticity of the digital certificate. Further details regarding digital certificates are described above.

The resource provider computer 108 may include any suitable computational apparatus operated by a resource provider. The resource provider computer 108 may be, for example, an access device or a point of sale device. In some embodiments, the resource provider computer 108 may include a web server computer that may host one or more websites associated with the resource provider.

In some embodiments, the resource provider computer 108 may be configured to receive a digital identity certificate from the user device 104 including identity information. As used herein, receiving the digital identity certificate may refer to receiving a subset of the information associated with the digital identity certificate. In some embodiments, the user may provide a copy or an instance of the digital identity certificate including all or a portion of the information associated with the digital identity certificate. In some embodiments, the resource provider computer 108 generates a transaction authorization request message including the digital identity certificate. In some embodiments, the resource provider computer 108 transmits the transaction authorization request message to the processing network computer 110 for additional transaction processing.

The processing network computer 110 may include data processing subsystems, networks, and operations used to support and deliver authorization services, perform account name lookups, verify digital certificate signatures using public signatures received from the certification authority computer 102, generate tokens, validate tokens, and transmit tokens for subsequent use, and is described above and below.

The authorizing entity computer 112 is operated by an authorizing entity. An example of an authorizing entity can be an issuer, which can be an entity (e.g., a bank) which issues and maintains user accounts for its users. The authorizing entity computer 112 may issue payment devices for user accounts (e.g., consumer accounts), including credit cards, debit cards, and virtual cards. The authorizing entity computer 112 may provision one or more user accounts on the user device 104. The authorizing entity computer 112 may be configured to conduct authorization processes.

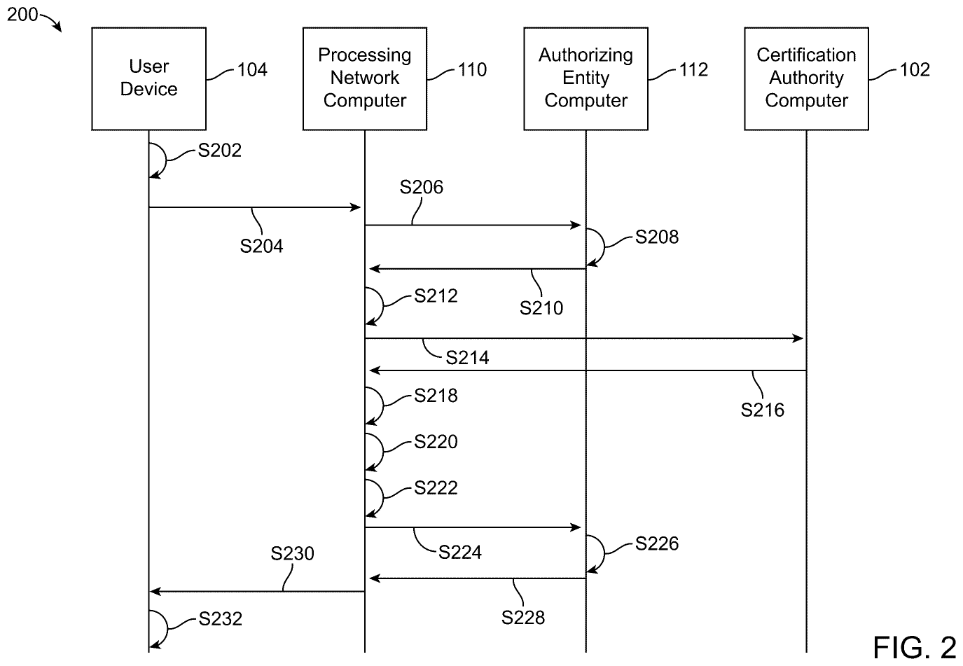

FIG. 2 illustrates a flowchart 200 for provisioning a token to a digital wallet using a digital identity certificate (e.g., a mobile driver's license), according to an embodiment. The digital identity certificate may be referred to as a digital certificate. Flowchart 200 includes a user device 104 (e.g., user device 104 described above), a processing network computer 110 (e.g., processing network computer 110 described above), an authorizing entity computer 112 (e.g., authorizing entity computer 112 described above), and a certification authority computer 102 (e.g., certification authority computer 102 described above). Flowchart 200 illustrates processing that can be performed by system 100 to provision the token to a digital wallet application that runs on the user device 104.

At step S202, the user may download and set up a digital wallet application (e.g., described above with respect to applications 106) capable of adding the digital certificate. The user may configure the digital wallet application by adding a user account issued by the authorizing entity computer 112. The user account may be used for future transactions such as purchases and fund transfers. The user account may be added using account identifying information (e.g., account number, etc.). In an example, a payment card can be added to the digital wallet application.

The user may interact with an agency (e.g., the certification authority computer 102) that issued the digital certificate (e.g., a user may interact with the DMV that issued a driver's license) to provision the digital certificate (e.g., a mDL) on the user device 104. The user may have to perform a series of steps prescribed by the certification authority computer 102 to successfully provision the mDL on the user device 104. The digital wallet application may be updated to include (e.g., store locally, store remotely) the digital certificate (e.g., a digital identity certificate) issued by the certification authority computer 102). The certification authority computer 102 may manage (e.g., update the information associated with the underlying digital certificate, etc.) the digital certificate on the user device 104 via the digital wallet application.

At step S204, the user device 104 may generate and transmit a token provisioning request, a relying party request for signature validation of the user's certificate, and an Account Name Inquiry (ANI) check request to the processing network computer 110. The token provisioning request may request a token (e.g., a previously generated token, a token that will be generated after the request) that represents a user account. The relying party request may be generated by the user device 104, which is relying on a signature validation of a certificate issued by the certification authority computer 102. The ANI check request may be included in an ISO message or handled via an application programming interface (API), and include the account identifying information. User device 104 may transmit the digital certificate (e.g., including a subset of information associated with the digital certificate or a copy of all information associated with the digital certificate) and/or the identity information to the processing network computer 110. The processing network computer 110 may receive the token provisioning request, the relying party request, and the Account Name Inquiry (ANI) check, the digital certificate, the identity information, and/or the account identifying information from the user device 104.

At step S206, the processing network computer 110 may transmit the ANI check request to the authorizing entity computer 112, which may be the issuer of the user account. The ANI check request may be included in an ISO message or handled using an API. The ANI check request may include the account identifying information provided to the digital wallet application by the user at step S202 and be used to request and retrieve account name information. The ANI check request can be used to request account name information associated/linked with the account identifying information for the user account.

At step S208, the authorizing entity computer 112 may use the account identifying information to determine account name information associated/linked with the account identifying information for the user account. The determination can be made using a lookup table or another data structure that can represent relationships between stored data.

At step S210, the authorizing entity computer 112 may transmit the account name information to the processing network computer 110.

At step S212, after the authorizing entity computer 112 retrieves the account name information associated with the account identifying information from the authorizing entity computer 112, the processing network computer 110 can validate the account name information corresponds to the identify information received from the user device 104 at step S204. The identity information may be retrieved from the information associated with the digital certificate. Validating the account name information corresponds to the identify information may be performed using various logic. For example, a last name of a user indicated by the account name information is compared with a last name of the user indicated by the identify information. If the last names match, it may result in a successful validation. The above example is a simple logic example. Other implementations are also considered, such as if the last names fields are almost identical (e.g., because a last name was spelled wrong for the identify information or the account name information). Other implementations may additionally or alternatively compare other fields of information included in the account name information with the fields of information included in the identify information, such as a first name, a middle name, a date of birth, a gender, etc.

By performing the comparison, a level of confidence that the identify information included in the digital certificate corresponds with the user associated with the account name information can be determined. In certain embodiments, a confidence score is determined and the confidence score is checked against a predetermined threshold. For example, an exact match between the two sets of information may result in a high score, and a close or partial match due to a typo in the information may be a lower but potentially still acceptable score. A person of ordinary skill in the art with the benefit of the present disclosure would recognize other logic that may be performed to validate the identity information received from user device 104 corresponds with the account name information provided by the authorizing entity computer 112. In certain embodiments, if the validation is successful, step S214 is performed as a result. In certain embodiments, if the validation is not successful, an indication of a failed validation is transmitted to the user device 104, and processing of the provisioning request stops.

In certain embodiments, the validation step described with respect to step S212 may be performed by the authorizing entity computer 112 before step S210. For example, the ANI check request at step S206 may additionally include the identity information received from the user device 104 so the authorizing entity computer 112 can validate the account name information corresponds to the identify information. In such embodiments, the authorizing entity computer 112 may transmit an indication of whether the validation was successful to the processing network computer at step S210.

At step S214, processing network computer 110 may request a public key from the certification authority computer 102. The certification authority computer 102 that the request is transmitted to may be determined based on the application on the user device 104 that manages the digital certificate and/or information included in the digital certificate (e.g., information identifying the certification authority). By determining the certification authority computer 102 associated with the digital certificate, the public key associated with the certification authority that issued the digital certificate can be identified. In some embodiments, the public key may have been previously provided to the processing network computer 110 by the certification authority computer 102, for example upon creation of the digital certification by the certification authority computer 102, or before. In certain embodiments, the public key associated with the digital certificate is identified from a set of public keys stored by the user device 104 based on a mapping between public keys and digital certificates. Public keys have been described above in further detail.

The public key may be part of a public/private key pair. The private key of the public/private key pair may have been used by the certification authority computer 102 to digitally sign the digital certificate (e.g., before the digital certificate was transmitted to the user device 104. By digitally signing the digital certificate using the private key, the public key can be used by the processing network computer 110 and/or other computers to determine an authenticity of the certificate (e.g., to validate the digital certificate, indicating whether any information represented by the digital certificate was altered since the private key was used to digitally sign the digital certificate).

At step S216, the public key may be transmitted to the processing network computer 110. In certain embodiments, the processing network computer 110 receives the public key from the certification authority once and the public key can be used to validate many and/or subsequent digital certificates issued by the certification authority computer 102.

At step S218, the processing network can validate/authenticate the digital certificate and/or information (e.g., at least a portion of the identity information) included in the digital certificate received from the user device 104 at S204 using the public key. The public key can be applied to the digital certificate to determine whether the certification authority computer 102 issued the digital certificate and whether any changes have been made to the digital certificate after its generation by the certification authority computer 102.

In certain embodiments, the processing network computer 110 authenticates the digital signature of the digital certificate before step S206 because the digital certificate was previously authenticated as part of another token provisioning process.

In certain embodiments, one or more of steps S214, S216, and S218 are completed before or concurrently with one or more of steps S206, 208, and S212. In certain embodiments, one or more of steps S214, S216, and S218 are completed before receiving account identifying information and/or the identity information from the user device 104.

At step S220, a token may be generated by the processing network computer 110. The token may be generated after S218 and/or S212. The token may be generated along with a token identifier that can be used to identify the token and determine which user account is associated with the token.

At step S222, the processing network computer 110 may generate a token confirmation request. The token confirmation request may include the token, the account name information, the digital certificate, and/or an identifier of the token. The token confirmation request may include a first indication that the validation completed during step S212 was successful. The token confirmation request may include a second indication of whether the signature of the digital certificate was validated during step S218. The validation performed by the processing network computer 110 (e.g., an entity that the authorizing entity computer 112 trusts) helps authorizing entity computer 112 associate the digital certificate with the user account.

At step S224, the processing network computer 110, may transmit the token confirmation request to the authorizing entity computer 112.

At step S226, the authorizing entity computer 112 may validate the user account and/or the account name information. The validation may occur by checking that the account name information includes information (e.g., an account holder name) that is associated with the user account the token is associated with (e.g., the user account the token represents). The authorizing entity computer 112 may validate that the user account is valid (e.g., is active).

In certain embodiments, validation may occur using a validation prompt transmitted to the user device 104 (e.g., via a push notification to a banking application, via email, via text, etc.) of the user associated with the user account. If the user validation prompt results in receiving user input that indicates a validation approval, the user account and/or account name information may be validated, indicating an account holder's approval of associating the token with the user account of the account holder.

The authorizing entity computer 112 may generate a token validation result based on whether the validation (e.g., account holder validation, account validation, etc.) of the token was successful or not successful. Additionally, at step S226, the authorizing entity computer 112 may store an association between the digital certificate and the user account.

At step S228, the authorizing entity computer 112 may transmit the token validation result to the processing network computer 110. If the token is validated, the processing network computer 110 may associate the token representing the account identifying information with the digital certification and/or identity information. As a result of associating the token representing the account identifying information with the digital certificate, the digital certificate can be transformed into a payment credential. By transforming the digital certificate into a payment credential, the digital certificate gains additional functionality, since the digital certificate can be used as an account credential in addition to its previous function (e.g., as an identification in the case of a mDL).

The token may be associated with the user account associated with the account identifying information by the processing network computer 110. The token may be associated with the digital certificate by the processing network computer 110. The associations may be stored in a data structure (e.g., a table) so that if the account identifying information is subsequently received by the processing network computer 110 (e.g., from the user device 104), the processing network computer 110 can determine the token and/or the user account. The associating can be performed by the processing network computer 110 after step S228 or step S220.

At step S230, the processing network computer 110 may transmit a message to user device 104 (e.g., to the application running on the user device 104, to a service provider application). The message may include the token or the token identifier generated at step S220, the indication of the validation completed as part of step S212 was successful, and/or an authentication result indicating that authentication completed as part of step S218 was successful. The token may be transmitted if the token validation was indicated as successful in step S228. The message may indicate that the digital certificate provisioning is complete with respect to the user account. The message may indicate that digital certificate has been provisioned and is ready for use in transactions.

At step S232, the token or the token identifier may be stored in memory of the user device 104. The token or the token identifier may be stored by the digital wallet application and/or service provider application running on the user device 104. The token may be associated in memory with the digital certificate. Responsive to receiving the message, the application may cause user device 104 to present an output (e.g., a notification on a display) that notifies a user of the user device 104 about the decision made by the authorizing entity computer 112 (e.g., issuer) to regarding provisioning of the user account. The token may be stored by the user device 104. After the provisioning of the token on the application is complete using the digital certificate, the user device can initiate transactions using the provisioned digital certificate (e.g., for making payments). In some embodiments, the token can be transmitted to conduct subsequent interactions instead of transmitting a digital certificate, account identifying information, other information related to the account. In some embodiments, the digital certificate may be presented to conduct a transaction, without providing the token or any other account identifying information.

In conventional systems, the authorizing entity computer 112 and the processing network computer 110 would not have access to the digital certificate (e.g., mDL) and/or the user identifying information provided with the digital certificate, thereby requiring a separate authentication process to be completed with the user device 104. According to embodiments described herein, the processing network computer 110 can now verify the ANI, verify the digital certificate, send the ANI and digital certificate together to the authorizing entity computer 112 for confirmation. The authorizing entity computer 112 can review the received information, review the data available to the authorizing entity computer 112, and determine whether the provision request can be completed.

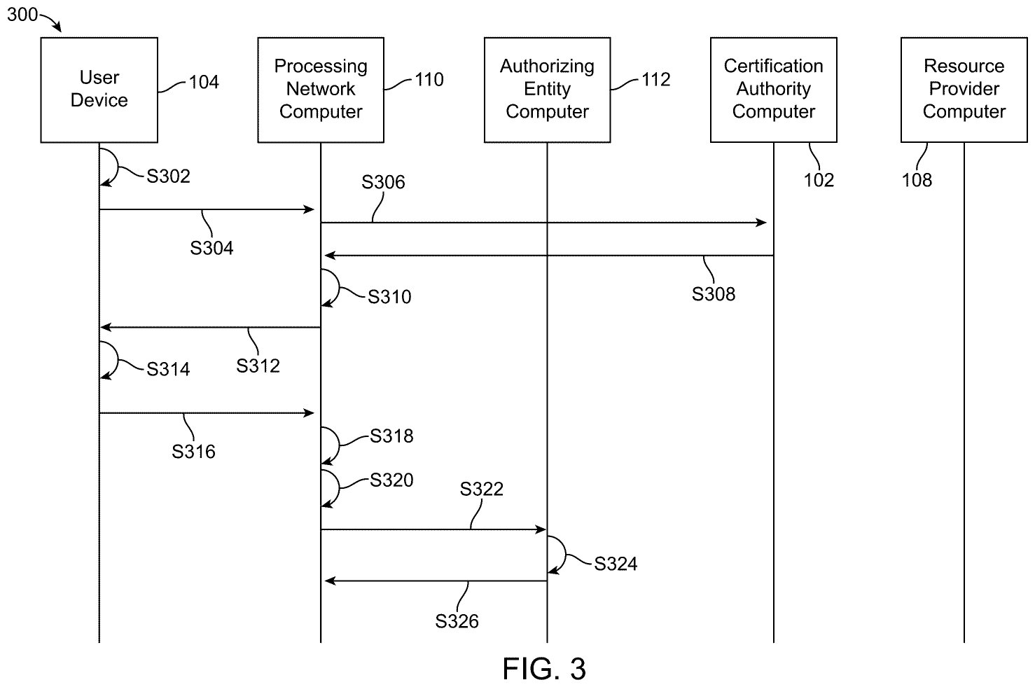

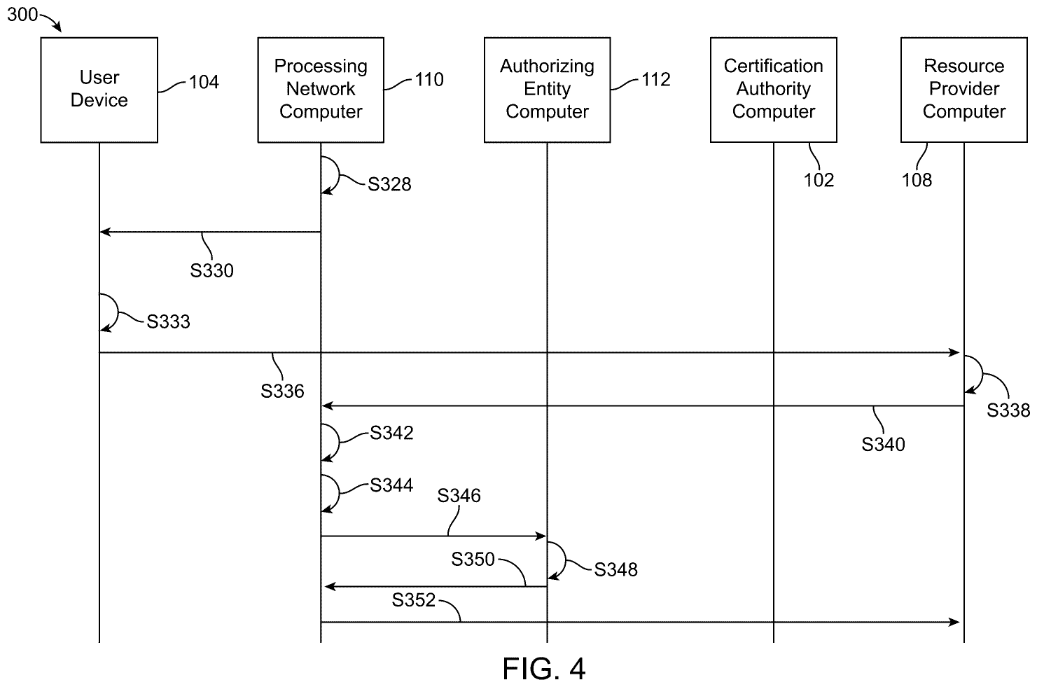

FIGS. 3-4 illustrate a flowchart 300 for processing a payment transaction using a digital identity certificate (e.g., a mobile driver's license), according to an embodiment. Flowchart 300 includes a user device 104 (e.g., user device 104 described above), a processing network computer 110 (e.g., processing network computer 110 described above), an authorizing entity computer 112 (e.g., authorizing entity computer 112 described above), a certification authority computer 102 (e.g., certification authority computer 102 described above), and a resource provider computer 108 (e.g., resource provider computer 108 described above). Flowchart 300 illustrates processing that can be performed by system 100 to use a digital certificate (e.g., the digital identity certificate such as a mDL) as a substitute for a payment credential during a transaction (e.g., a rental car transaction).

Step S302 through step S334 describe a flow similar to the flow described with respect to FIG. 2 for provisioning a token to an application (e.g., digital wallet application and/or service provider application) running on the mobile device and/or the mobile device. Steps S302 through S334 describe a different order of operations that is possible.

At step S302, an application of the user device 104 may be configured in a similar manner to that described with respect to S202.

At step S304, the application running on user device 104 may transmit a digital certificate (e.g., a mDL) to the processing network computer 110. Step S304 may be similar to S204 described above.

At step S306, the processing network computer 110 may transmit a request for a public key of the certification authority computer 102 to the certification authority computer 102 and may be performed similarly to step S214.

At step S308, the certification authority computer 102 may transmit the public key of the certification authority to the processing network computer 110. Step S308 may be similar to step S214 described above.

At step S310, the processing network computer 110 may authenticate the digital certificate using the public key received from the certification authority computer 102. Step S310 may be similar to step S218 described above. An authentication result may be generated including information indicating whether the digital certificate is authentic or not.

At step S312, the processing network computer 110 may transmit the authentication result to the application on the user device 104. Such result may have been transmitted to the application during step S230 described above.

At step S314, if the authentication result indicates that the digital certificate is authentic, the application may cause the user device 104 to associate the digital certificate with a user account. The user account may be an account of the user using the user device 104 and/or application. The user may be the user associated with the digital certificate (e.g., a mDL “holder”). Responsive to receiving the authentication result, the application may cause user device 104 to present an output (e.g., a notification on a display) that notifies a user of the user device 104 about the authentication of the digital certificate performed by the processing network computer 110.

At step S316, the application may transmit a token generation request to the processing network computer 110. The token generation request may include account identifying information. The account identifying information may identify the user account that the digital certificate was associated with at step S314. The token generation request may include the digital certificate. The digital certificate may be included so the processing network computer 110 can validate an account name matches the identify information included in the digital certificate. The digital certificate may be included so the processing network computer 110 can associate a token that is generated with the digital certificate, enabling the digital certificate to be used in lieu of (e.g., as a proxy for) an account credential.

At step S318, the token may be generated by the processing network computer 110. Step S318 may be similar to step S220 described above. The token may include a token identifier that can be used to identify the token, determine which user account is associated with the token, and/or determine the token associated with a digital certificate.

At step S320, the processing network computer 110 may generate a token confirmation request like the token confirmation request described with respect to step S222 described above.

At step S322, the processing network computer 110 may transmit the token confirmation request to the authorizing entity computer 112. Step S322 may be similar to step S224 described above.

At step S324, the authorizing entity computer 112 may validate the user account and/or account name information responsive to receiving the token confirmation request. Step S324 may be similar to step S226 described above.

At step S326, the authorizing entity computer 112 may transmit token the validation result from step S324 to the processing network computer 110. Step S326 may be similar to step S228 described above.

At step S328, the processing network computer 110 may associate the token with the user account. The processing network computer 110 may additionally or alternatively associate the token with the digital certificate. The association can be stored using a data structure such as a table that stores a mapping between tokens (e.g., token identifiers) and user account (e.g., account identifiers). The mapping may be generated by the processing network computer 110 so that when a digital certificate is received from the user device 104 and/or the resource provider computer 108, the user account can be determined. The mapping may be generated by the processing network computer 110 so that when a token and/or token identifier is received from the user device 104 and/or the resource provider computer 108 after the token is provisioned to the application on user device 104, the user account can be determined.

In certain embodiments, the mapping is established between the digital certificate and the token so that when the digital certificate is received from the user device 104 and/or from the resource provider computer 108, the token can be retrieved by the processing network computer 110 from a token vault using the information from the digital certificate, and transmitted to the authorizing entity computer 112.

At step S330, the processing network computer 110 may transmit a message to user device 104 (e.g., to the application running on the user device 104, to a service provider application). The message may include the indication of whether validation completed as part of step S324 was successful, and/or an authentication result indicating whether authentication completed as part of step S310 was successful. The message may indicate that the digital certificate provisioning is complete with respect to the user account (e.g., that the digital certificate can be used to conduct transactions).

At step S333, responsive to receiving the message, the user device 104 may present output (e.g., a notification on a display) that notifies a user of the user device 104 about processing performed in any of steps S302 through S332.

At step S336, the user may visit a merchant store that allows identity (e.g., mDL or another digital certificate) as a method of payment. In some embodiments, the store may have a resource provider computer 108 (e.g., a Point of Sale (POS) system) compatible with the identity verification payment method. The user device 104 may be presented at the resource provider computer 108. For example, the user device 104 may be presented at the resource provider computer 108 during a tap-to-access interaction. The tap to access interaction may involve tapping the user device 104 to an NFC reader of the resource provider computer 108 to initiate a funds transfer or a resource (e.g., physical space) access request. The user device 104 may transmit the digital certificate to the resource provider computer 108 in lieu of an account credential.

At step S338, the resource provider computer 108 may generate a transaction authorization request message. The transaction authorization request message may include the digital certificate. The transaction authorization request message may include the identify information. The transaction authorization request message may include a transaction amount and/or merchant identifying information associated with a transaction. The transaction amount may have been generated by the resource provider computer 108 based on input received by a user interface of the resource provider computer 108.

At step S340, the resource provider computer 108 may transmit the transaction authorization request message to the processing network computer 110.

At step S342, the processing network computer 110 may authenticate the digital certificate. The authentication may be performed using the public key of the certification authority computer 102 (e.g., as described above). In certain embodiments, if the authentication is not successful, the processing network computer 110 may transmit an indication of the unsuccessful authentication to the user device 104 and terminate processing of the authorization request for the interaction with the resource provider. In certain embodiments, if the authentication is successful, the flow continues to step S344.

At step S344, the digital certificate may be used to retrieve the token associated with the digital certificate (e.g., associated with the digital certificate at step S328). The token may be retrieved by performing a lookup/search in the data structure that stores the relationship between the digital certificate and the token. The token can be used to process the transaction indicated by the transaction authorization request message.

At step S346, the processing network computer 110 may generate a second transaction authorization request message including the transaction amount, and the token. The second transaction authorization request message may include additional information that was included in the first authorization request message such as one or more of a transaction location and/or a resource provider identifier. The second transaction authorization request message may be transmitted to the authorizing entity computer 112.

At step S348, the authorization entity computer 112 may use the token and/or the transaction amount to authorize the transaction. In some embodiments, the transaction may be authorized based on the transaction amount being below a certain threshold associated with the token (and therefore with the mDL). The transaction may be authorized based on conditions associated with the user account associated with the token.

At step S350, a first authorization response message to the second authorization request may be generated by the authorization entity computer 112 and transmitted to the processing network computer 110. The first authorization response message may indicate whether the transaction was authorized or denied by the authorizing entity computer 112.

At step S352, a second authorization response message may be generated by the processing network computer 110 and transmitted to the resource provider computer 108. Upon receiving the first authorization response message, the processing network computer 110 may replace the token with the corresponding digital certificate (e.g., mDL) in the second authorization response message. This way, the token is never communicated to the resource provider computer 108. The second authorization response message may indicate whether the transaction was authorized or denied by the authorizing entity computer 112. After the resource provider computer 108 receives the second authorization response message, the resource provider computer 108 may present an indication of whether the transaction was authorized or denied by the authorizing entity computer 112. After the resource provider computer 108 receives the second authorization response message, the resource provider computer 108 may transmit the second authorization response message to the user device 104 (e.g., so the user device 104 can present an indication of whether the transaction was authorized or denied by the authorizing entity computer 112).

In certain embodiments, the processing network computer 110 may have multiple tokens associated with (e.g., mapped to) the digital certificate. For example, the user device 104 may store a digital certificate that can be used to conduct transactions using a first account or a second account. The first account and/or the second account may be a user account (e.g., an account for government benefits, a disaster relief account, a charitable assistance account, a health account, an account for disability disbursement, an account for education disbursement, an account for insurance disbursement, a pension account, a personal bank account, etc.). The processing network computer 110 may be capable of determining a token associated with the digital certificate from a plurality of tokens associated with the identity information based at least in part on transaction information (e.g., transaction amount, transaction location, and/or transaction time, type of resource provider, identity of the resource provider, etc.) included in a transaction authorizing request message and the digital identity certificate. The processing network computer 110 may determine the authorization entity computer to transmit the token to based on information associated with the token and/or the authorization computer previously communicated with during a provisioning process.

The flow described above illustrates how a digital certificate can be used as (e.g., transformed into) a credential that can be used with a resource provider to conduct a transaction. The embodiments can improve security by reducing information transmitted to and stored by a resource provider computer 108. Further, the embodiments can improve the user device 104 by reducing the amount of memory that is needed to be used by the user device 104 to conduct transactions compared to previous techniques since the techniques described herein enable the user device 104 to use a digital certificate to conduct a transaction and therefore the user device 104 may not need to store the account information and may not need to transmit the account information to the resource provider computer 108. Since account information is not transmitted to the resource provider computer 108 from the user device 104, less bandwidth is used and network utilization becomes more efficient. Since less transmissions occur, the user device 104 and/or the resource provider computer 108 may also consume less energy as a result.

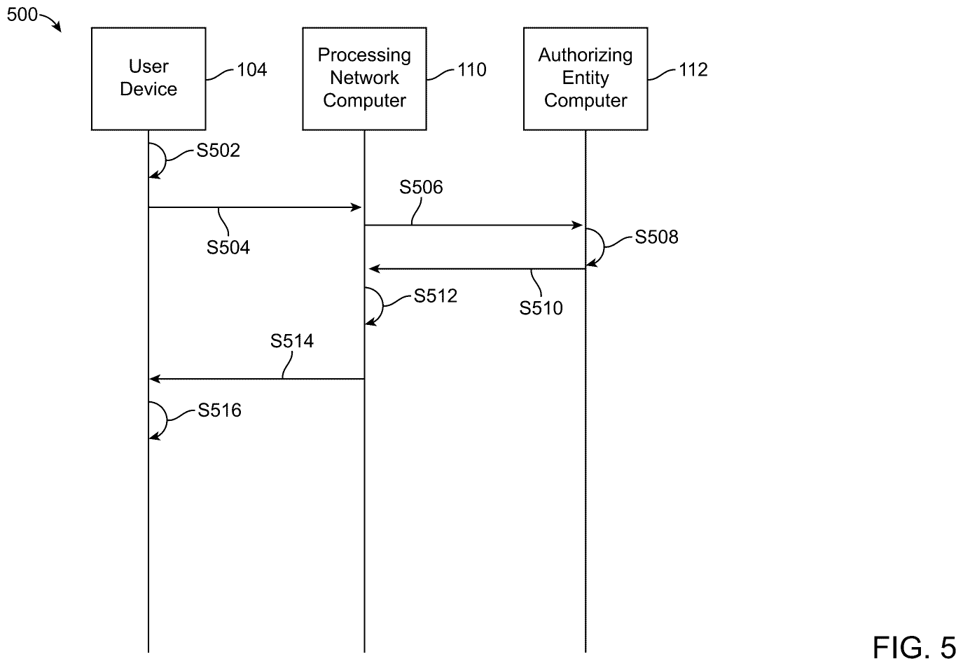

FIG. 5 illustrates a flowchart 500 for mitigating unauthorized card use using a digital identity certificate, according to an embodiment. Flowchart 500 includes a user device 104 (e.g., user device 104 described above), a processing network computer 110 (e.g., processing network computer 110 described above), and an authorizing entity computer 112 (e.g., authorizing entity computer 112 described above).

Conventional systems that use fund transfer applications are susceptible to fraud when a fraudster provisions a stolen card to their fund transfer application. For example, if a fraudster is in possession of a stolen payment device (e.g., credit card), the fraudster can provision the payment device to the fund transfer app by entering the accountholder name as it appears on the payment device. Embodiments described avoid or mitigate the unauthorized card usage fraud at the time of provisioning the card in the fund transfer application because provisioning the card relies on a digital certificate (e.g., a mDL) stored by the user device 104. As a result, a fraudster with a fraudster's mDL on a user device 104 would not be able to provision a victim's card to the fraudster's user device 104. Flowchart 500 illustrates how embodiments that use a digital certificate can mitigate fraud.

At step S502, a fraudster using user device 104 may attempt to add victim account identifying information to an application (e.g., a digital wallet or a service provider application) running on the user device 104. As an example, the account identifying information may include a primary account number (PAN), an expiration date, and a card verification value. Step S502 may be performed similar to step S202.

At step S504, the funds transfer application executing on the user device 104 may generate and transmit a relying party request including the digital certificate retrieved from the user device 104. The funds transfer application may receive the digital certificate from another application (e.g., a digital wallet application) on the user device 104. The relying party request may be for signature validation of the user's digital certificate, and an Account Name Inquiry (ANI) check request to the processing network computer 110. The ANI check request may be included in an ISO message, or API call, and include the account identifying information. User device 104 may transmit the digital certificate to the processing network computer 110.

The processing network computer 110 may receive the relying party request including the Account Name Inquiry (ANI) check, the fraudster digital certificate (e.g., the digital certificate from the fraudster user device 104), and/or the account identifying information from the user device 104.

At step S506, the processing network computer 110 may transmit the ANI check request to the authorizing entity computer 112, which may be the issuer of the user account. The ANI check request may be included in an ISO message or an API call. The ANI check request may include the victim account identifying information provided to the digital wallet application by the user at step S502 and be used to retrieve account name information (e.g., account information about the victim). The ANI check request can be used to request account name information associated/linked with the victim account identifying information for the victim user account. Step S506 may be performed similar to step S206.

At step S508, the authorizing entity computer 112 may use the victim account identifying information to determine victim account name information associated/linked with the victim account identifying information for the victim user account. The determination can be made using a lookup table or another data structure that can represent relationships between stored data. Step S508 may be performed similar to step S208.

At step S510, the authorizing entity computer 112 may transmit the victim account name information to the processing network computer 110. Step S510 may be performed similar to step S210.

At step S512, after the authorizing entity computer 112 retrieves the victim account name information associated with the victim account identifying information from the authorizing entity computer 112, the processing network computer 110 can validate whether the victim account name information corresponds to the fraudster identify information received from the user device 104 at step S204. The processing performed by the processing network computer 110 can determine that the fraudster identity information does not correspond to the victim account identifying information (e.g., using the processing described with respect to step S212).

At step S514, the processing network computer 110 may transmit, to the user device 104, an indication of the inability to successfully validate the victim account identifying information responsive to step S512.

At step S516, after the user device 104 receives the indication from the processing network computer 110, the user device 104 may present the indication (e.g., via a user interface of the user device 104). The indication may indicate to the fraudster user of the user device 104 that the account identifying information cannot be used by the application.

The processing depicted in flowcharts 200, 300, and 500, and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in flowcharts 200, 300, and 500, and other FIGS. and described herein are intended to be illustrative and non-limiting. Although flowcharts 200, 300, and 500, and other FIGS. depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in flowcharts 200, 300, and 500, and other FIGS, may include a greater number or a lesser number of steps than those depicted in the respective FIGS.

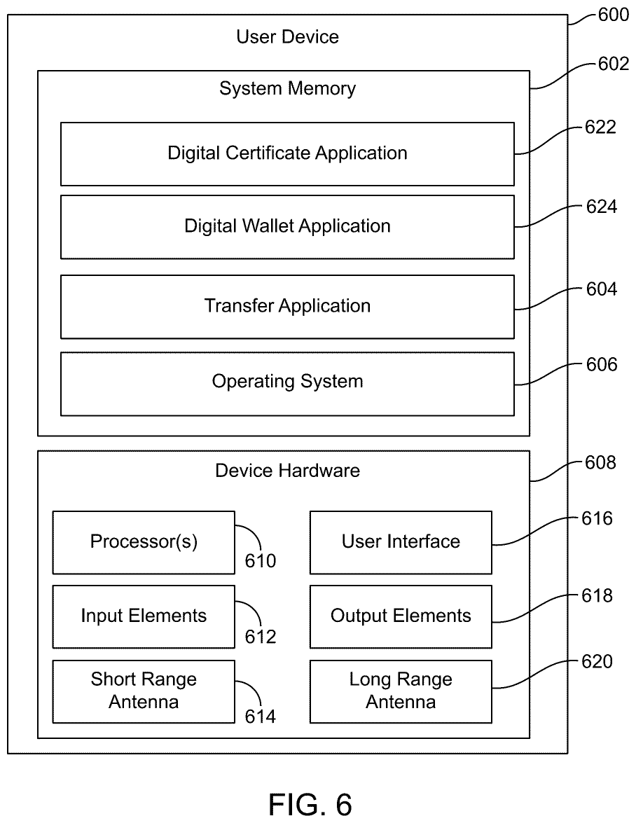

FIG. 6 shows a block diagram of a user device 104 (e.g., user device 104, described above), according to an embodiment. The user device 104 can be a mobile device (e.g., mobile phone, smart watch, tablet, etc.) with a digital certificate application 622, a digital (e.g., electronic) wallet application 624, a transfer application 604, and an operating system 606. The user device 104 can be capable of performing tasks described herein. The user device 104 may include device hardware 608 coupled to a system memory 602. The user device 104 can perform the functions described herein.

Device hardware 608 may include a processor 610, input elements 612, a short range antenna 614, a user interface 616, output elements 618, and a long range antenna 620. Examples of input elements 612 may include microphones, keypads, touchscreens, sensors, and/or cameras, etc. Examples of output elements 618 may include speakers, display screens, tactile devices, and/or light emitting diodes (LEDs), etc. The processor 610 can be implemented as one or more integrated circuits (e.g., one or more single core or multicore microprocessors and/or microcontrollers), and is used to control the operation of user device 104. The processor 610 can execute a variety of programs in response to program code or computer-readable code stored in the system memory 602, and can maintain multiple concurrently executing programs or processes.

The long range antenna 620 may include one or more radio frequency (RF) transceivers and/or connectors that can be used by user device 104 to communicate with other devices and/or to connect with external networks. The input elements 612 and output elements 618 allow a user to interact with and invoke the functionalities of user device 104. The short range antenna 614 may be configured to communicate with external devices through a short range communication medium (e.g., using Bluetooth, Wi-Fi, infrared, NFC, etc.). The long range antenna 620 may be configured to communicate with a remote base station and a remote cellular or data network, over the air.

The system memory 602 can be implemented using any combination of any number of non-volatile memories (e.g., flash memory) and volatile memories (e.g., DRAM, SRAM), or any other non-transitory storage medium, or a combination thereof media. The system memory 602 may store computer code, executable by the processor 610, for performing any of the functions described herein. For example, the system memory 602 may comprise a computer readable medium comprising code, executable by the processor 610, for implementing a method as described herein.

For example, the method may include transmitting to a processing network computer 110, a digital certificate and account identifying information. The method may further include receiving a token from the processing network computer 110 and storing the token. In certain embodiments, the token may be associated with the account identifying information.

The system memory 602 may also store the digital certificate application 622 (e.g., an mDL application), the digital wallet application 624, the transfer application 604, and the operating system 606. The transfer application 504 may include instructions or code implementing a transfer application 504 for sending a transfer of funds to a first account from a second account using the digital identification certificate (stored by the digital certification application 622) as the payment credential. The transfer application 504 may include instructions or code implementing a transfer application 504 for receiving a transfer of funds from a first account by a second account. The digital certificate application 622 may store a government-issued identification such as a driver's license. The digital certification application 622 can allow users to present their digital certificate for identity verification, age verification, and other official purposes, as well as a payment credential, often using encrypted technology to ensure privacy and security.

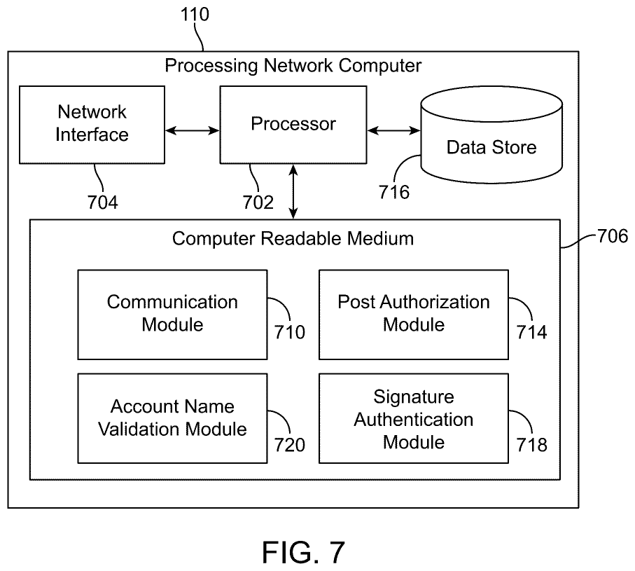

FIG. 7 shows a block diagram of a processing network computer 110 (e.g., processing network computer 110 described above), according to an embodiment. The processing network computer 110 may include a processor 702, coupled to a network interface 704, a data store 716, and a computer readable medium 706.

The data store 716 can be implemented using any combination of any number of non-volatile memories (e.g., flash memory) and volatile memories (e.g., DRAM, SRAM), or any other non-transitory storage medium, or a combination thereof media. The data store 716 may store tokens, credentials, encryption keys, digital certificates, account identifying information, and/or other information as described herein.

The computer readable medium 706 may comprise a number of software modules including a communication module 710, a post authorization processing module 714, an account name validation module 720, and a signature authentication module 718.

The communication module 710 may comprise code, executable by the processor 702, to communicate using network interface 704 with one or more other systems. The post authorization processing module 714 may comprise code, executable by the processor 702, to perform clearing and settlement processing. The account name validation module 720 may comprise code, executable by the processor 702, to compare account name information with identity information or other information included in a digital certificate (e.g., step S212, described above). The signature authentication module 718 may comprise code, executable by the processor 702, to authenticate the digital certificate (e.g., as described above with respect to step S218).

Embodiments of the invention provide for a number of advantages. For example, embodiments can avoid or reduce fraudulent transactions because account identifying information can be checked against information included in a digital certificate during provisioning of a token and/or during a transaction. Additionally, embodiments can improve security my reducing information transmitted to and stored by a resource provider computer. Security can also be improved because a payment credential and a certificate (e.g., an identification, a mDL) can both be represented by the digital certificate simultaneously, thereby reducing opportunities for malicious actors to try have a system think a credential is associated with a certificate, when it should not be. Further, the embodiments can improve the user device by reducing the amount of memory that is needed to be used by the user device to conduct transactions compared to previous techniques since the techniques described herein can enable the user device to use a digital certificate to conduct a transaction and therefore the user device may not need to store the account information and may not need to transmit the account information to the resource provider computer. Since account information is not transmitted to the resource provider computer from the user device, network utilization may become more efficient since less bandwidth may be used. Since less transmissions occur, the user device and/or the resource provider computer may also consume less energy as a result.

Embodiments can provide techniques and logic at a global scale to authenticate a trusted entity (e.g., government) issued digital certificate (e.g., driver's license, passport) from anywhere in the world to anywhere in the world. Embodiments allow for the real time cryptographic digital authentication of a trusted entity (e.g., government) issued digital certificate during a financial or financial related transaction. Embodiments provide rapid strong authentication of a government issued digital certificate.

In some embodiments, a processing entity may collect and validate the authenticity of both the issuing government department and that department's public key used to prove the origin and integrity of the issued digital credential. All these keys would be housed securely at the processing entity and access to the keys may be provided via a processing entity API to the relying parties worldwide.

In some embodiments, the processing entity may sign the issuing government party public key thereby creating a government public key certificate. Embodiments therefore significantly enhance security against spoofing and provide a single processing entity root key that can extract and authenticate the government department public key in both offline and online modes.

In some embodiments, a welfare recipient may benefit from the techniques described herein because the welfare recipient may be able to use their digital certificate to conduct a welfare transaction (e.g., a food stamp transaction, an insurance payout transaction, etc.) without having to physically go somewhere to show their identification certificate because their digital certificate can act as a trusted identifier of the recipient (e.g., because it is signed by a certification authority) and because information represented by the digital certificate can be checked to see if it matches information associated with the recipient (e.g., making sure the name of the intended recipient is the same as the name represented by the digital certificate). As another benefit of the techniques described herein, in certain cases a user may be more likely to lose track of a physical driver's license (or other certificate) than they are to lose track of a mDL (or other digital certificate) because many users carry their phones (or other user device) with them more often than many other objects (e.g., a wallet, a passport, a physical driver's license, etc.).

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a processing network computer from a user device, account identifying information associated with a user account and a digital identity certificate including identity information;
associating, by the processing network computer, a token representing the account identifying information with the digital identity certificate; and
transmitting, by the processing network computer, a message to the user device indicating that the digital identity certificate provisioning is complete with respect to the user account, wherein the digital identity certificate provisioning transforms the digital identity certificate to be a proxy for the user account.

2. The method of claim 1, further comprising:
receiving, by the processing network computer, a transaction authorization request message from a resource provider computer, the transaction authorization request message including the digital identity certificate and a transaction amount associated with a transaction;
retrieving, by the processing network computer, the token associated with the digital identity certificate; and
processing, by the processing network computer, the transaction using the token.

3. The method of claim 1, wherein associating the token with the digital identity certificate comprises:
retrieving, from an authorizing entity computer, account name information associated with the account identifying information;
validating the identity information corresponds with the account name information provided by the authorizing entity computer; and
authenticating a signature of the identity information using a public key associated with a certification authority and part of a key pair that includes a private key used to sign the identity information, wherein the certification authority manages the digital identity certificate on the user device.

4. The method of claim 3, wherein authenticating the signature further comprises:
identifying, by the processing network computer, the public key associated with the certification authority that issued the digital identity certificate; and
authenticating, by the processing network computer, the digital identity certificate using the public key.

5. The method of claim 3, wherein validating the identity information corresponds with the account name information comprises determining if a first field included in the identity information matches a second field included in the account name information.

6. The method of claim 1, further comprising:
transmitting a request to an authorizing entity computer requesting account name information, the request including the account identifying information;
receiving the account name information; and
comparing the account name information to the identity information.

7. The method of claim 1, wherein the digital identity certificate is stored by the user device.

8. The method of claim 1, wherein the digital identity certificate is received from a service provider application running on the user device, and wherein the message is transmitted to the service provider application.

9. The method of claim 1, further comprising:
prior to receiving the account identifying information and the identity information from the user device:
receiving, by the processing network computer, the digital identity certificate from the user device;
authenticating, by the processing network computer, the digital identity certificate; and
transmitting, by the processing network computer, an authentication result, generated by the authenticating, to the user device.

10. The method of claim 9, wherein authenticating the digital identity certificate further comprises:
identifying, by the processing network computer, a public key associated with a certification authority that issued the digital identity certificate; and
authenticating, by the processing network computer, the digital identity certificate using the public key by verifying a signature of the identity information using the public key associated with the certification authority and part of a key pair that includes a private key used to sign the identity information, wherein the certification authority manages the digital identity certificate on the user device.

11. A processing network computer comprising:
one or more storage media storing instructions; and
one or more processors configured to execute the instructions to cause the processing network computer to perform operations comprising:
receiving, from a user device, account identifying information associated with a user account and a digital identity certificate including identity information;
associating a token representing the account identifying information with the identity information; and
transmitting a message to the user device indicating that the digital identity certificate provisioning is complete with respect to the user account, wherein the digital identity certificate provisioning transforms the digital identity certificate to be a proxy for the user account.

12. The processing network computer of claim 11, wherein the processors execute the instructions, further causing the processing network computer to perform operations further comprising:
receiving a transaction authorization request message from a resource provider computer, the transaction authorization request message including the identity information associated with the digital identity certificate and a transaction amount associated with a transaction;
retrieving the token associated with the identity information; and
processing the transaction using the token.

13. The processing network computer of claim 11, wherein associating the token with the digital identity certificate comprises executing the instructions causing the processors to perform operations comprising:
retrieving, from an authorizing entity computer, account name information associated with the account identifying information;
validating the identity information corresponds with the account name information provided by the authorizing entity computer; and
authenticating a signature of the identity information using a public key associated with a certification authority and part of a key pair that includes a private key used to sign the identity information, wherein the certification authority manages the digital identity certificate on the user device.

14. The processing network computer of claim 13, wherein authenticating the signature comprises executing the instructions causing the processors to perform the operations comprising:
identifying the public key associated with the certification authority that issued the digital identity certificate; and
authenticating the digital identity certificate using the public key.

15. The processing network computer of claim 14, wherein validating the identity information corresponds with the account name information comprises determining if a first field included in the identity information at least partially matches a second field included in the account name information.

16. The processing network computer of claim 11, wherein the processors execute the instructions, further causing the processing network computer to perform operations further comprising:
transmitting a request to an authorizing entity computer requesting account name information, the request including the account identifying information;
receiving the account name information; and
comparing the account name information to the identity information.

17. The processing network computer of claim 11, wherein the digital identity certificate provisioning transforms the digital identity certificate into a payment credential.

18. A method comprising:
receiving, by a processing network computer from a resource provider computer for a transaction, a first transaction authorization request message that includes a digital identity certificate including identity information and transaction information associated with the transaction;
determining, by the processing network computer, a token associated with the identity information from a plurality of tokens associated with the identity information based at least in part on the transaction information and the digital identity certificate;
retrieving, by the processing network computer, the token;
generating, by the processing network computer, a second transaction authorization request that includes the token;
transmitting, by the processing network computer and to an authorizing entity computer, the second transaction authorization request;
receiving, by the processing network computer and from the authorizing entity computer, a first transaction authorization response message generated based at least in part on the token; and
transmitting, by the processing network computer and to the resource provider computer, a second transaction authorization response message indicating whether the transaction was authorized.

19. The method of claim 18, wherein the token is associated with at least one of: an account for government benefits, a disaster relief account, a charitable assistance account, a health account, an account for disability disbursement, an account for education disbursement, an account for insurance disbursement, a pension account, or a personal bank account.

20. The method of claim 18, wherein determining the token comprises:
searching for an identifier of the token included in a data structure storing a set of token identifiers using at least the identity information and the transaction information.
